(19) United States
(12) Patent Application Publication
(10) Pub. No.: US 2024/0127282 A1
(43) Pub. Date: Apr. 18, 2024

(54) LISTED PRODUCT INFORMATION CHECK SYSTEM AND STORAGE MEDIUM

(71) Applicant: Rakuten Group, Inc., Tokyo (JP)

(72) Inventors: Danaipat SODKOMKHAM, Tokyo (JP); Wingin Chau, Tokyo (JP)

(21) Appl. No.: 18/487,363

(22) Filed: Oct. 16, 2023

(30) Foreign Application Priority Data
Oct. 17, 2022 (JP) 2022-166391

(51) Int. Cl. G06Q 30/0207; G06V 10/74; G06V 20/60

(52) U.S. Cl. CPC G06Q 30/0225; G06Q 30/0222; G06V 10/761; G06V 20/60

(57) ABSTRACT

To allow an administrator of a service to easily identify a product page on which inappropriate product information is displayed, provided is a listed product information check system which acquires regular sale product information without discount from among a plurality of pieces of product information each including image information and document information, acquires discount sale product information with discount, calculates an image similarity, extracts regular sale product information including similar image information calculates a document similarity between the document information included in the extracted regular sale product information and the document information included in the discount sale product information, and outputs information on one piece of discount sale product information when a piece of regular sale product information determined to satisfy a given condition based on the image similarity and the document similarity exists in the extracted regular sale product information.

### CROSS-REFERENCE TO RELATED APPLICATION

The present disclosure contains subject matter related to that disclosed in Japanese Priority Patent application 2022-166391 filed in the Japan Patent Office on Oct. 17, 2022, the entire contents of which are hereby reference.

### BACKGROUND OF THE INVENTION

### 1. Field of the Invention

The present disclosure relates to a listed product information check system and a storage medium.

### 2. Description of the Related Art

In recent years, online shopping that uses the Internet or the like has become popular, and a user can use services such as purchase of a product sold by a shop opened in a shopping mall on the Internet. On a product page on which this service is provided, product information on a product, such as a seller of the product, a product name, a product image, a product description, and a price, are displayed. This product information is provided to a platform of the service by, for example, the seller or a vendor.

It is preferred that an administrator of the service check whether or not the product information displayed on the product page on the Web is appropriate in light of terms and laws. For example, in Japanese Patent No. 5778880, there is disclosed a warning device which gives a warning for a contradiction caused between a registered trading price and the details of contents described in a product page used for trading.

### SUMMARY OF THE INVENTION

Incidentally, in order to attract customers, the seller may list, only in a predetermined sale period, a product at a price lower than that in a non-sale period, which is a period other than this sale period. Moreover, an administrator of the service may specify a predetermined sale period, and a plurality of sellers may simultaneously list products at prices lower than those in the non-sale period in this specified period.

However, some sellers may list, in the sale period, products at the same prices as those in the non-sale period while advertising that the prices are lower than those in the non-sale period, to thereby attract the customers. As described above, it is preferred that the administrator of the service check whether or not the product information displayed on the product page is appropriate. However, when the number of the listed products is enormous, it is difficult to identify the product pages on which the displayed product information is inappropriate.

It is an object of the present disclosure to provide a listed product information check system and a program for allowing an administrator of a service to easily identify a product page on which inappropriate product information is displayed.

According to at least one embodiment of the present disclosure, there is provided a listed product information check system including at least one processor configured to: acquire a plurality of pieces of regular sale product information without discount from among a plurality of pieces of product information each including image information representing an image of a product and document information including a name of the product; acquire one piece of discount sale product information with discount from among the plurality of pieces of product information; calculate an image similarity being a similarity between the image information included in the one piece of discount sale product information and the image information included in each of the plurality of pieces of regular sale product information, and extract one or more pieces of regular sale product information including the image information similar to the image information included in the one piece of discount sale product information from among the acquired plurality of pieces of regular sale product information; calculate a document similarity between the document information included in each of the extracted one or more pieces of regular sale product information and the document information included in the one piece of discount sale product information; and output at least information on the one piece of discount sale product information when a piece of regular sale product information determined to satisfy a given condition based on the image similarity and the document similarity exists in the extracted one or more pieces of regular sale product information.

In one aspect of the present disclosure, the product information is associated with seller information representing a seller of the product, and the at least one processor is configured to: acquire the one piece of discount sale product information associated with given seller information; and acquire the plurality of pieces of regular sale product information based on the given seller information.

In one aspect of the present disclosure, the at least one processor is configured to determine that the image information included in the one piece of discount sale product information and the image information included in the each of the plurality of pieces of regular sale product information are similar to each other when a distance represented by a feature vector of the image information included in the one piece of discount sale product information and a feature vector of the image information included in the each of the plurality of pieces of regular sale product information is shorter than a predetermined threshold value.

In one aspect of the present disclosure, the at least one processor is configured to: calculate a score represented as a value that is larger as the image similarity is higher and is larger as the document similarity is higher; and determine that the given condition is satisfied when the score is larger than a predetermined value.

In one aspect of the present disclosure, each of the plurality of pieces of product information further includes price information on the product, and the at least one processor is configured to extract only a piece of regular sale product information including the price information which is equal to the price information included in the one piece of discount sale product information or is different from the one piece of discount sale product information by a predetermined amount or less.

In one aspect of the present disclosure, the at least one processor is configured to: access an electric commerce system including: a product information storage module configured to store the plurality of pieces of product information; and a product page generation module configured to generate, based on each of the plurality of pieces of product information stored in the product information storage module, a product page including the seller information associated with the each of the plurality of pieces of product information and the image information, the document information, and the price information that are included in the each of the plurality of pieces of product information; and acquire the plurality of pieces of regular sale product information from the product information storage module.

In one aspect of the present disclosure, the at least one processor is configured to: transmit, to the product page generation module, a discount sale request for the product page relating to the one piece of discount sale product information and a regular sale request for the product page relating to the piece of regular sale product information determined to satisfy the given condition; acquire the product page generated based on the discount sale request and the product page generated based on the regular sale request; and output information represented by an image obtained by unifying two or more of the acquired product pages.

In one aspect of the present disclosure, the at least one processor is configured to: acquire a plurality of pieces of discount sale product information with discount; and output, for each of the plurality of pieces of discount sale product information, a combination of information on the plurality of pieces of discount sale product information and the piece of regular sale product information determined to satisfy the given condition.

In one aspect of the present disclosure, the document information further includes information representing a quantity of the product.

According to at least one embodiment of the present disclosure, there is provided a non-transitory computer-readable storage medium having stored thereon a program to be executed by a computer. The program causes the computer to function as a listed product information check system configured to: acquire a plurality of pieces of regular sale product information without discount from among a plurality of pieces of product information each including image information representing an image of a product and document information including a name of the product; acquire one piece of discount sale product information with discount from among the plurality of pieces of product information; calculate an image similarity being a similarity between the image information included in the one piece of discount sale product information and the image information included in each of the plurality of pieces of regular sale product information, and extract one or more pieces of regular sale product information including the image information similar to the image information included in the one piece of discount sale product information from among the acquired plurality of pieces of regular sale product information; calculate a document similarity between the document information included in each of the extracted one or more pieces of regular sale product information and the document information included in the one piece of discount sale product information; and output at least information on the one piece of discount sale product information when a piece of regular sale product information determined to satisfy a given condition based on the image similarity and the document similarity exists in the extracted one or more pieces of regular sale product information.

According to the at least one embodiment of the present disclosure, the administrator of the service can easily identify the product page on which inappropriate product information is displayed.

### BRIEF DESCRIPTION OF THE DRAWINGS

FIG. 1 is a diagram for illustrating an example of a schematic configuration of hardware of an entire electronic commerce system.

FIG. 2 is a diagram for illustrating functional blocks of the electric commerce system and a listed product information check system.

FIG. 3 is a table for showing an example of product information stored in a product information storage module.

FIG. 4 is a table for showing an example of product information stored in the product information storage module.

FIG. 5 is a view for illustrating an example in which a generated product page is displayed on a browser.

FIG. 6 is a table for showing calculation of a document similarity.

FIG. 7 is a view for showing an example of image information output by an output module.

FIG. 8 is a flowchart for illustrating an example of processing executed in the listed product information check system.

### DETAILED DESCRIPTION OF THE INVENTION

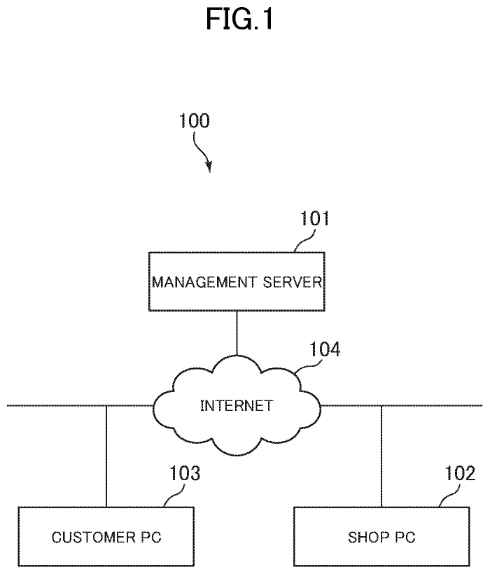

FIG. 1 is a diagram for illustrating an example of a schematic configuration of hardware of an entire electronic commerce system 100. As illustrated in FIG. 1, the electronic 25 commerce system 100 includes a management server 101, a shop PC 102, and a customer PC 103. Moreover, the management server 101, the shop PC 102, and the customer PC 103 can mutually transmit and receive data via Internet 104. In FIG. 1, a state in which one shop PC 102 and one customer PC 103 are connected to the Internet 104 is illustrated, but the number of shop PCs 102 and the number of customer PCs 103 are usually two or more.

The management server 101 is a server device which executes various types of processing relating to an online shopping mall at which products can be purchased. The management server 101 is an information processing device, and executes processing relating to transmission of a product page relating to a product, search for and purchase of a product, and the like in response to a request from the shop PC 102 and the customer PC 103.

The shop PC 102 is a terminal device to be used by an employee of a shop opened in the online shopping mall and the like. The shop PC 102 accesses a server device such as the management server 101 based on an operation of the employee or the like. As a result, the shop PC 102 receives the product page from the server device, and displays the product page. The employee uses the shop PC 102 to, for example, register information on a product to be sold in the online shopping mall and to check details of an order for the product.

The customer PC 103 is a terminal device of a user who purchases a product from the online shopping mall. The customer PC 103 accesses the management server 101 based on an operation of the user, to thereby receive a product page from the management server 101 and display the product page. Software, such as a browser and an electronic mail client, are built into the customer PC 103. As the customer PC 103, for example, a personal computer, a personal digital assistant (PDA), a portable information terminal such as a smartphone, a cell phone, or the like is used.

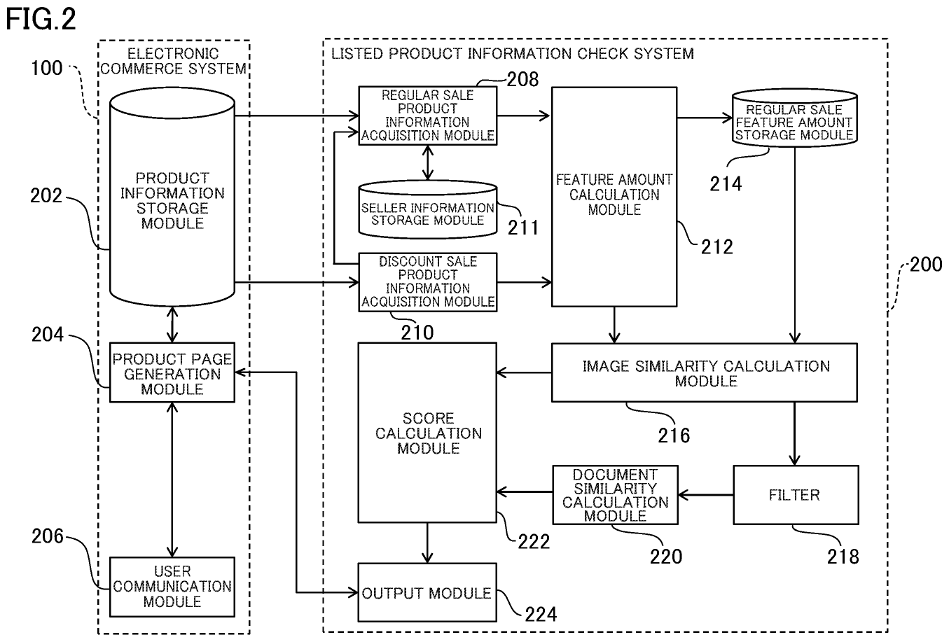

FIG. 2 is a diagram for illustrating functional blocks of the electric commerce system 100 and a listed product information check system 200. In FIG. 2, only functions implemented by the management server 101 among functions of the entire electronic commerce system 100 are illustrated. Moreover, a case in which each function of the listed product information check system 200 is implemented by the management server 101 of FIG. 1 is described below, but each function of the listed product information check system 200 may be implemented by an information processing device (not shown) connected to the management server 101 via a LAN, an intra-company network, or the like.

As illustrated in FIG. 2, the electronic commerce system 100 includes a product information storage module 202, a product page generation module 204, and a user communication module 206.

The product information storage module 202 stores a plurality of pieces of product information. Specifically, for example, the product information storage module 202 stores the plurality of pieces of product information each being associated with a seller information representing a given seller, and each including image information representing an image of a product and document information representing a name of this product. The document information may further include information representing a quantity of the product. The image information is image data representing an image of the product displayed on a product page. The document information is a description of the product displayed on the product page, and is expressed by a text (string). The document information may include not only the name and the quantity of the product but a document describing a place of production and a state of the product.

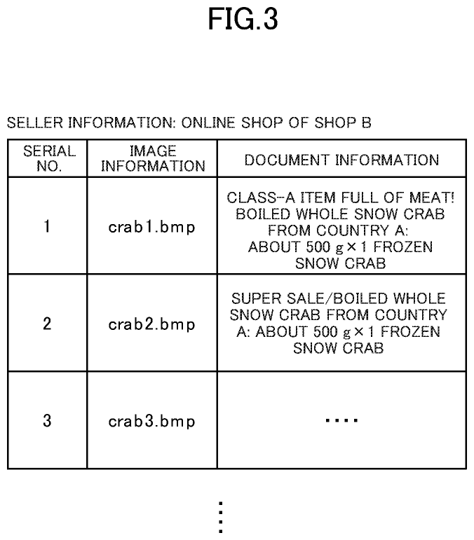

FIG. 3 is a table for showing an example of the product information stored in the product information storage module 202. The table of FIG. 3 is associated with seller information of “online shop of shop B” and includes a plurality of pieces of product information. Each piece of product information shown in FIG. 3 includes a serial No. for identifying each piece of product information. The image information of the product information having a serial No. of “1” is “crab1.bmp” and the document information is “Class-A item full of meat! Boiled whole snow crab from country A: about 500 g×1 Frozen snow crab.” The image information of the product information having a serial No. of “2” is “crab2.bmp” and the document information is “Super SALE/Boiled whole snow crab from country A: about 500 g×1 Frozen snow crab.” The table of FIG. 3 includes product information having serial No. of “3” and later.

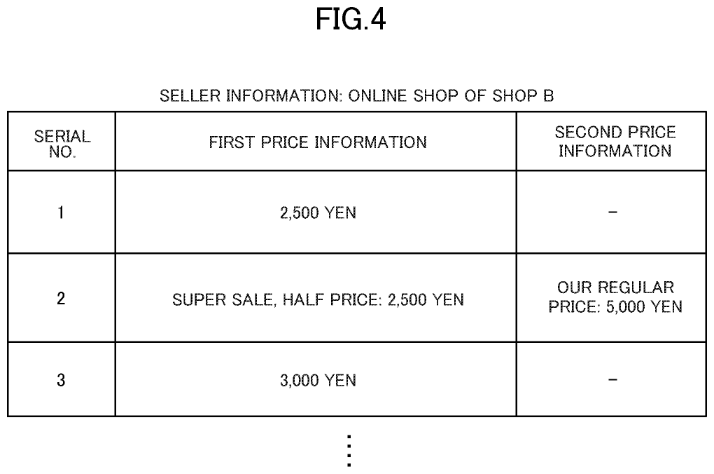

The product information storage module 202 further stores the product information including price information on the product. Specifically, the price information is information representing a price of the product represented by this product information, and a plurality of pieces of price information may be included in one piece of product information. For example, FIG. 4 is a table for showing an example of product information including the price information on the products, and each piece of product information includes first price information and second price information. The first price information is information representing an actual trading price, and the second price information is information representing a price before discount when a discount sale is to be conducted. As shown in FIG. 4, the price information may include not only numerical information indicating the sale price, but also text information indicating a state of regular sale and a state of discount sale.

The table of FIG. 4 is a table corresponding to the table of FIG. 3, is associated with the seller information of “online shop of shop B,” and includes at least the product information having the serial No. of “1” to the serial No. of “3.” The first price information on the product information having the serial No. of “1” is “2,500 yen,” and the second price information is “Null.” The first price information on the product information having the serial No. of “2” is “Super sale, half price: 2,500 yen,” and the second price information is “our regular price: 5,000 yen.” The first price information of the product information having the serial No. of “3” is “3,000 yen,” and the second price information is “Null.”

The product information including the price information of FIG. 4 and the product information including the image information and the document information of FIG. 3 may be stored as one table in the product information storage module 202.

The product page generation module 204 generates, based on the product information stored in the product information storage module 202, a product page including the seller information associated with this product information and the image information, the document information, and the price information that are included in this product information. Specifically, for example, the product page generation module 204 first acquires a request for the product page relating to the product information having the serial No. of “1.” The product page generation module 204, which has acquired this request, generates a product page including a text file in which the strings “Online shop of shop B,” “Class-A item full of meat! Boiled whole snow crab from country A: about 500 g×1 Frozen snow crab,” and “2,500 yen” are written at predetermined positions and an image file being “crab1.bmp” in the hypertext markup language (HTML).

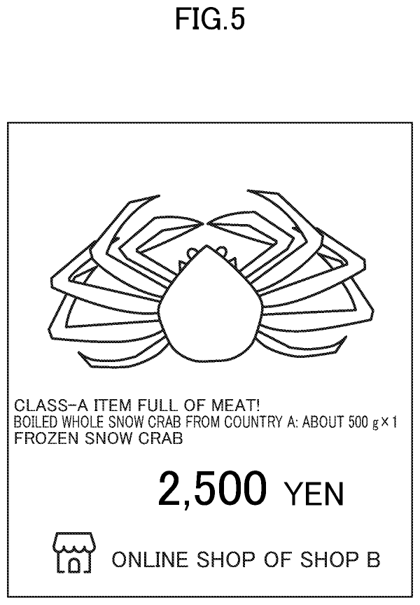

The product page generation module 204 generates a product page in accordance with a predetermined model. FIG. 5 is a view for illustrating an example in which the generated product page is displayed on the browser. An image represented by the image file being “crab1.bmp” is shown in an upper portion. The text “Class-A item full of meat! Boiled whole snow crab from country A: about 500 g×1 Frozen snow crab” being the document information is shown in a middle portion. The text “2,500 yen” being the first price information and the text “online shop of shop B” being the seller information are displayed in a lower portion. The customer PC 103 displays such a product page as illustrated in FIG. 5.

The user communication module 206 communicates to and from the shop PC 102 and the customer PC 103. Specifically, for example, the user communication module 206 receives a request for the product page relating to the product information from the customer PC 103 or an output module 224, and transmits this request to the product page generation module 204. Moreover, the user communication module 206 transmits the product page generated by the product page generation module 204 to the customer PC 103 or the output module 224 being the transmission source of this request.

The listed product information check system 200 includes a regular sale product information acquisition module 208, a discount sale product information acquisition module 210, a seller information storage module 211, a feature amount calculation module 212, a regular sale feature amount storage module 214, an image similarity calculation module 216, a filter 218, a document similarity calculation module 220, a score calculation module 222, and the output module 224.

The regular sale product information acquisition module 208 acquires a plurality of pieces regular sale product information without discount from among a plurality of pieces of product information each including the image information representing the image of the product and the document information including the name of this product. Specifically, for example, the regular sale product information acquisition module 208 accesses the electronic commerce system 100 to randomly acquire the plurality of pieces of regular sale product information without discount from among the plurality of pieces of product information each including the image information representing the image of the product and the document information including the name and the quantity of this product.

The discount sale product information acquisition module 210 acquires one piece of discount sale product information with discount from among the plurality of pieces of product information. Specifically, for example, the discount sale product information acquisition module 210 accesses the electronic commerce system 100 to randomly acquire the one piece of discount sale product information with discount that includes the image information representing the image of the product and the document information including the name and the quantity of this product.

The discount sale product information acquisition module 210 may acquire one piece of discount sale product information associated with given seller information. Specifically, for example, the discount sale product information acquisition module 210 may acquire product information including the second price information from the product information associated with the seller information being “online shop of shop B.” For example, as shown in FIG. 4, the product information having the serial No. of “2” includes the second price information, and hence the discount sale product information acquisition module 210 acquires the product information having the serial No. of “2.”

In this case, the regular sale product information acquisition module 208 may acquire a plurality of pieces of regular sale product information based on the given seller information. Specifically, the regular sale product information acquisition module 208 may acquire product information not including the second price information from the product information associated with the seller information being “online shop of shop B.” For example, in the table of FIG. 4, pieces of product information that are associated with the seller information being “online shop of shop B” and has the serial No. of “1” and the serial No. of “3” in the table of FIG. 4 do not include the second price information. In this case, the regular sale product information acquisition module 208 may acquire the product information having the serial No. of “1” and the serial No. of “3.”

Moreover, the seller information associated with the discount sale product information acquired by the discount sale product information acquisition module 210 and the seller information associated with the regular sale product information acquired by the regular sale product information acquisition module 208 is not required to be the same. For example, it is only required that the seller information associated with the discount sale product information and the seller information associated with the regular sale product information have a given association. The given association is, for example, a capital relationship of sellers represented by those two pieces of seller information, an association specified in advance by an administrator of the service, or the like. A plurality of pieces of seller information having the predetermined association are stored in advance in the seller information storage module 211.

The seller information storage module 211 stores the plurality of pieces of seller information having the given association. Specifically, for example, the seller information storage module 211 stores one or more tables including a list of seller information specified in advance by the administrator of the service. For example, when the seller who uses the seller information being “online shop of shop B” to list products uses different seller information being “online shop of shop b” to sell other products, the product information storage module 202 stores the seller information being “online shop of shop B” and the seller information being “online shop of shop b” as different pieces of seller information. In this case, the seller information storage module 211 stores the seller information being “online shop of shop B” and the seller information being “online shop of shop b” in one table as one group of pieces of seller information having the given association.

As a result, the regular sale product information acquisition module 208 can acquire the regular sale product information based on the plurality of pieces of seller information stored in the seller information storage module 211 and having the given association. For example, when the discount sale product information acquisition module 210 acquires the discount sale product information from the product information associated with the seller information being “online shop of shop B,” the regular sale product information acquisition module 208 can acquire the regular sale product information from product information associated with the seller information being “online shop of shop b” based on the one table stored in the seller information storage module 211. As a result, even when the seller uses different pieces of seller information of “online shop of shop B” and “online shop of shop b,” the administrator of the service can identify a product page on which inappropriate product information is displayed.

The feature amount calculation module 212 calculates a feature amount of each piece of image information included in the product information acquired by the regular sale product information acquisition module 208 and the discount sale product information acquisition module 210. Specifically, for example, the feature amount calculation module 212 calculates a feature vector of the image data being “crab1.bmp” included in the product information having the serial No. of “1,” a feature vector of the image data being “crab2.bmp” included in the product information having the serial No. of “2,” and a feature vector of the image data being “crab3.bmp” included in the product information having the serial No. of “3.” As a calculation method for the feature vector, a known method may be used.

The regular sale feature amount storage module 214 stores the feature amount of each piece of image information included in the product information acquired by the regular sale product information acquisition module 208. Specifically, for example, the regular sale feature amount storage module stores the feature vector of the image data being “crab1.bmp” and the feature vector of the image data being “crab3.bmp.”

The image similarity calculation module 216 calculates an image similarity being a similarity between the image information included in the one piece of discount sale product information and the image information included in each of the plurality of pieces of regular sale product information, and extracts one or more pieces of regular sale product information including the image information similar to the image information included in the one piece of discount sale product information from the plurality of pieces of regular sale product information acquired by the regular sale product information acquisition module 208. Specifically, for example, the image similarity calculation module 216 calculates the feature vector of the image information included in the one piece of discount sale product information and the feature vector of the image information included in the regular sale product information. Then, when a distance represented by the feature vector calculated based on the discount sale product information and the feature vector calculated based on the regular sale product information is shorter than a predetermined threshold value, the image similarity calculation module 216 determines that the image information included in the one piece of the discount sale product information and the image information included in the regular sale product information are similar to each other. In the above-mentioned example, a distance represented by the feature vector of the image data being “crab1.bmp” stored in the regular sale feature amount storage module 214 and the feature vector of the image data being “crab2.bmp” is calculated as the image similarity. Moreover, when this distance is shorter than the predetermined threshold value, the image similarity calculation module 216 determines that the image information included in the discount sale product information and the image information included in the regular sale product information are similar to each other. For example, when the difference in feature vector between “crab1.bmp” and “crab2.bmp” is smaller than the threshold value, and the difference in feature vector between “crab3.bmp” and “crab2.bmp” is larger than the threshold value, the image similarity calculation module 216 extracts product information having the serial No. of “1.”

The method of using the feature vector is an example of the method of calculating the image similarity, and the image similarity calculation module 216 may use another publicly-known method to calculate the image similarity. For example, the image similarity calculation module 216 may calculate a difference in gradation value for each pixel, to thereby calculate a magnitude of a sum of the differences of the entire image as the similarity. When the feature vector is not used, the feature amount calculation module 212 and the regular sale feature amount storage module 214 may be omitted.

Moreover, the image similarity calculation module 216 may extract only the regular sale product information including the price information equal to the price information included in the one piece of the discount sale product information or different therefrom by a predetermined amount or less. It is possible to extract only product information having high necessity for the check by avoiding extraction of the regular sale product information including the price information that is greatly different from the price represented by the price information included in the discount sale product information.

The filter 218 selects a part of the plurality of pieces of product information extracted by the image similarity calculation module 216. Specifically, for example, the filter 218 selects only product information on products other than outlet products by excluding the product information on the outlet products of the plurality of pieces of product information extracted by the image similarity calculation module 216.

The document similarity calculation module 220 calculates a document similarity between the document information included in each of the one or more regular sale product information extracted by the image similarity calculation module 216 and the document information included in the one piece of discount sale product information. Specifically, for example, the document similarity calculation module 220 uses a machine learning model which executes natural language processing to calculate the document similarity. In the above-mentioned example, the document similarity calculation module 220 calculates the similarity between the extracted document information included in the product information having the serial No. of “1” and the extracted document information included in the product information having the serial No. of “2.”

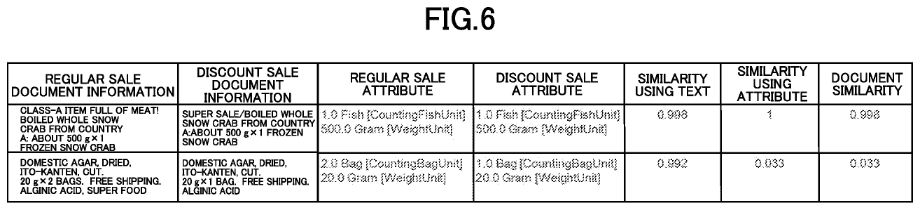

The calculation of the document similarity is specifically described with reference to a table shown in FIG. 6. The document similarity calculation module 220 uses the machine learning model which executes the publicly-known natural language processing to calculate a similarity of “0.998” from the text “Class-A item full of meat! Boiled whole snow crab from country A: about 500 g×1 Frozen snow crab” and the text “Super SALE/Boiled whole snow crab from country A: about 500 g×1 Frozen snow crab.”

Moreover, the document similarity calculation module 220 uses a publicly-known technology to extract information (hereinafter referred to as “attribute”) relating to a quantity and a size from the text. For example, the document similarity calculation module 220 extracts, from the text “Class-A item full of meat! Boiled whole snow crab from country A: about 500 gxl Frozen snow crab,” a regular sale attribute “1.0 Fish [CountingFishUnit] 500.0 Gram [WeightUnit].” Similarly, the document similarity calculation module 220 extracts, from the text “Super SALE/Boiled whole snow crab from country A: about 500 g×1 Frozen snow crab,” a discount sale attribute “1.0 Fish [CountingFishUnit] 500.0 Gram [WeightUnit].” Then, the document similarity calculation module 220 uses the above-mentioned machine learning model to calculate a similarity “1” using the attribute from the regular sale attribute and the discount sale attribute.

Further, the document similarity calculation module 220 calculates the document similarity being “0.998” by multiplying the similarity “0.998” using the text and the similarity “1” using the attribute.

The second row of FIG. 6 is another example relating to the calculation of the document similarity. The document similarity calculation module 220 uses the machine learning model which executes the publicly-known natural language processing to calculate a similarity being “0.992” using the text from a text “Domestic agar, dried, ito-kanten, cut. 20 g×2 bags. Free shipping. Alginic acid, super food” and a text “Domestic agar, dried, ito-kanten, cut. 20 g×1 bag. Free shipping. Alginic acid.”

Moreover, the document similarity calculation module 220 extracts the regular sale attribute “2.0 Bag [CountingBagUnit] 20.0 Gram [WeightUnit]” from the text “Domestic agar, dried, ito-kanten, cut. 20 g×2 bags. Free shipping. Alginic acid, super food.” Similarly, the document similarity calculation module 220 extracts the discount sale attribute “1.0 Bag [CountingBagUnit] 20.0 Gram [WeightUnit]” from the text “Domestic agar, dried, ito-kanten, cut. 20 g×1 bag. Free shipping. Alginic acid.” Then, the document similarity calculation module 220 uses the above-mentioned machine learning model to calculate a similarity “0.033” using the attribute from the regular sale attribute and the discount sale attribute.

Further, the document similarity calculation module 220 calculates a document similarity being “0.033” by multiplying the similarity “0.992” using the text and the similarity “0.033” using the attribute. That is, in the example shown on the second row of FIG. 6, the quantities of the product are different from each other, and hence a smaller similarity than that in the example shown on the first row of FIG. 6 is calculated.

The document similarity calculation module 220 may define the similarity using the text as the document similarity, or may define the similarity using the attribute as the document similarity. Moreover, the document similarity calculation module 220 may use another publicly-known method to calculate the document similarity.

The score calculation module 222 calculates a score represented as a value which is larger as the image similarity is higher and is larger as the document similarity is higher. Specifically, for example, the score calculation module 222 calculates a value obtained by multiplying the document similarity and the image similarity by each other as the score. The score may be calculated by another method as long as the score is represented as the value which is larger as the image similarity is higher and is larger as the document similarity is higher. Moreover, the score calculation module 222 may calculate a rank which is represented as five levels of, for example, “A” to “E” in accordance with the value of the score.

The output module 224 outputs at least information on the one piece of discount sale product information when the regular sale product information determined to satisfy a given condition based on the image similarity and the document similarity exists in the one or more pieces of regular sale product information extracted by the image similarity calculation module 216. Specifically, for example, as described above, it is assumed that the discount sale product information acquisition module 210 acquires the product information having the serial No. of “2” and the image similarity calculation module 216 extracts the product information having the serial No. of “1.” Moreover, it is assumed that the score calculation module 222 calculates the score representing the similarity between the product information having the serial No. of “1” and the product information having the serial No. of “2” as “0.998.” In this case, the output module 224 determines that the given condition is satisfied when the score is larger than a predetermined value (or closer to “A” than a predetermined character in the sequence of the alphabet from “A” to “Z”). Here, when the predetermined value is “0.9,” the output module 224 determines that the product information having the serial No. of “1” satisfies the given condition.

Further, the output module 224 transmits, to the product page generation module 204, a discount sale request for a product page relating to the one piece of discount sale product information and a regular sale request for a product page relating to the regular sale product information determined to satisfy the given condition. Specifically, in the above-mentioned example, the output module 224 transmits, to the product page generation module 204, the discount sale request for the product page relating to the discount sale product information having the serial No. of “2” and the regular sale request for the product page relating to the regular sale product information having the serial No. of “1.” After that, the product page generation module 204 generates the product page based on the discount sale request and the regular sale request. The output module 224 acquires the product page generated based on the discount sale request and the product page generated based on the regular sale request, and outputs image information obtained by unifying the acquired two or more product pages. The output image information is displayed by, for example, a display device (not shown) such as a liquid crystal display included in the management server 101. Moreover, the output image information may be printed on paper by a printer included in the management server 101.

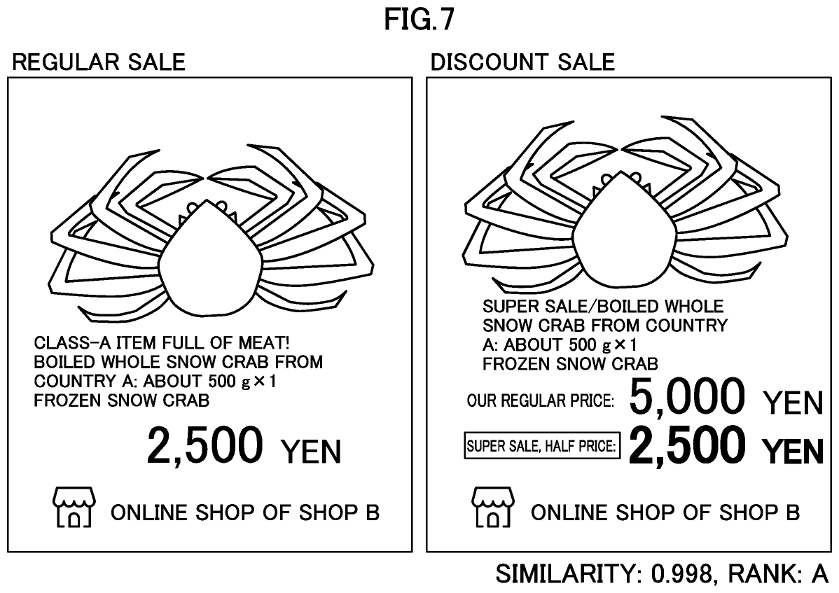

FIG. 7 is a view for showing an example of image information output by the output module 224. The image information of FIG. 7 is one piece of image data on which the product page relating to the regular sale product information (product information having the serial No. of “1”) and the product page relating to the discount sale product information (product information having the serial No. of “2”) are shown side by side for easy comparison. Output image information may include the similarity and the rank (lower right portion of FIG. 7) calculated by the score calculation module 222. Moreover, the output module 224 may output one piece of image data including only the product page relating to the discount sale product information. Further, the discount sale product information acquisition module 210 may acquire a plurality of pieces of discount sale product information with the discount. In this case, the output module 224 may output, for each piece of discount sale product information, a combination of information on the plurality of pieces of discount sale product information and the regular sale product information determined to satisfy the given condition.

As illustrated in FIG. 7, both of the product represented by the regular sale product information and the product represented by the discount sale product information are frozen snow crabs having the weight of 500 g, which are the same. Moreover, the prices of those two products are 2,500 yen, which are the same. However, in FIG. 7, it is displayed that the price of the product represented by the discount sale product information is not the regular price, but the price at the time of discount sale. Thus, the online shop of the shop B intends to sell the product while falsely claiming that the product which is 5,000 yen at the time of regular sale is discounted and sold at 2,500 yen. The administrator can easily recognize this dishonest sale practice by checking the image information illustrated in FIG. 7.

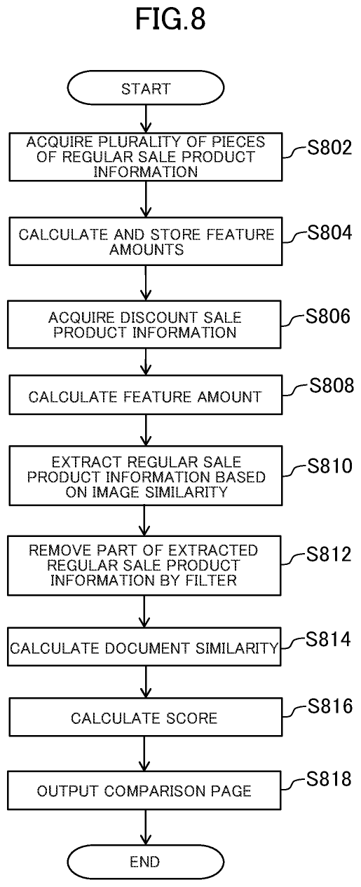

Moreover, the left side of FIG. 7 shows that the online shop of the shop B sells the product at 2,500 yen at the time of regular sale, but the right side of FIG. 7 shows that the online shop of the shop B sells the product at 5,000 yen at the time of regular sale. That is, the online shop of the shop B pretends to offer the discount by displaying that the price after the discount is 2,500 yen with respect to the comparison target price of 5,000 yen, the sale at which has not actually taken place. This practice is a practice corresponding to a dishonest dual price which gives consumers such impression that the sale price is low, which is false, by the display. According to the at least one embodiment of the present disclosure, the administrator can easily recognize this dishonest practice. FIG. 8 is a flowchart for illustrating an example of processing executed in the listed product information check system 200. Moreover, the processing illustrated in FIG. 8 is executed by the listed product information check system 200 operating in accordance with a listed product information check program.

First, the regular sale product information acquisition module 208 accesses the electronic commerce system 100, and acquires the regular sale product information from the product information storage module 202 (Step S802). For example, the regular sale product information acquisition module 208 acquires at least the product information having the serial No. of “1” and the serial No. of “3.” In Step S802, it is desired to acquire all pieces of regular sale product information without the discount among pieces of product information associated with the seller information representing a given seller.

Next, the feature amount calculation module 212 calculates the feature amount of each piece of image information included in the product information acquired in Step S802 (Step S804). Specifically, for example, the feature amount calculation module 212 calculates the feature vectors of the image data included in the product information having the serial No. of “1” and the serial No. of “3.” The regular sale feature amount storage module 214 stores the calculated feature vectors. Steps of Step S802 and Step S804 may be executed in advance independently of this flow.

Next, the discount sale product information acquisition module 210 acquires the discount sale product information with the discount that is associated with the seller information representing the given seller (Step S806). Specifically, for example, the discount sale product information acquisition module 210 acquires the product information having the serial No. of “2” from among the pieces of product information associated with the seller information being “online shop of shop B.”

Next, the feature amount calculation module 212 calculates the feature amount of each piece of image information included in the product information acquired in Step S806 (Step S808). Specifically, for example, the feature amount calculation module 212 calculates the feature vector of the image data included in the product information having the serial No. of “2.”

Next, the image similarity calculation module 216 calculates the image similarity, and extracts the regular sale product information including the image information similar to the image information included in the discount sale product information from among the plurality of pieces of regular sale product information acquired by the regular sale product information acquisition module 208 (Step S810). Specifically, for example, the image similarity calculation module 216 calculates an image similarity being “1” between “crab1.bmp” and “crab2.bmp” and an image similarity being “0.515” between “crab3.bmp” and “crab2.bmp.” When the threshold value is, for example “0.5,” the image similarity between “crab1.bmp” and “crab2.bmp” is 0.5 or more, and hence the image similarity calculation module 216 extracts product information having the serial No. of “1.”

The filter 218 selects a part of the plurality of pieces of product information extracted by the image similarity calculation module 216 (Step S812). Specifically, for example, when the product represented by the product information having the serial No. of “1” is not an outlet product, the filter 218 selects the product information having the serial No. of “1.”

Next, the document similarity calculation module 220 calculates the document similarity (S814). Specifically, for example, the document similarity calculation module 220 calculates a document similarity being “0.998” by multiplying the similarity “0.998” using the text and the similarity “1” using the attribute.

Next, the score calculation module 222 calculates the scores each represented as the value which is larger as the image similarity is higher and is larger as the document similarity is higher (Step S814). Specifically, for example, the score calculation module 222 multiplies the image similarity “1” and the document similarity “0.998” by each other to calculate the score being “0.998,” and calculates the rank being “A” corresponding to this value.

Next, the output module 224 outputs at least the information on the one piece of the discount sale product information when the regular sale product information determined to satisfy the given condition exists (Step S816). Specifically, for example, the output module 224 outputs the image information illustrated in FIG. 7.

With steps described above, the administrator can check the image information illustrated in FIG. 7 to easily recognize the dishonest practice. In general, the number of products listed by the same seller is enormous. Thus, it is difficult for the administrator to check product pages relating to all of the products, to thereby check whether or not inappropriate product information is displayed in each product page. According to the at least one embodiment of the present disclosure, as illustrated in FIG. 7, the administrator can easily recognize the dishonest sale practice by displaying the product page relating to the regular sale product information and the product page relating to the discount sale product information side by side for the easy comparison.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A listed product information check system, comprising at least one processor configured to:
acquire a plurality of pieces of regular sale product information without discount from among a plurality of pieces of product information each including image information representing an image of a product and document information including a name of the product;
acquire one piece of discount sale product information with discount from among the plurality of pieces of product information;
calculate an image similarity being a similarity between the image information included in the one piece of discount sale product information and the image information included in each of the plurality of pieces of regular sale product information, and extract one or more pieces of regular sale product information including the image information similar to the image information included in the one piece of discount sale product information from among the acquired plurality of pieces of regular sale product information;
calculate a document similarity between the document information included in each of the extracted one or more pieces of regular sale product information and the document information included in the one piece of discount sale product information; and
output at least information on the one piece of discount sale product information when a piece of regular sale product information determined to satisfy a given condition based on the image similarity and the document similarity exists in the extracted one or more pieces of regular sale product information.

2. The listed product information check system according to claim 1,
wherein the product information is associated with seller information representing a seller of the product, and
wherein the at least one processor is configured to:
acquire the one piece of discount sale product information associated with given seller information; and
acquire the plurality of pieces of regular sale product information based on the given seller information.

3. The listed product information check system according to claim 1, wherein the at least one processor is configured to determine that the image information included in the one piece of discount sale product information and the image information included in the each of the plurality of pieces of regular sale product information are similar to each other when a distance represented by a feature vector of the image information included in the one piece of discount sale product information and a feature vector of the image information included in the each of the plurality of pieces of regular sale product information is shorter than a predetermined threshold value.

4. The listed product information check system according to claim 1, wherein the at least one processor is configured to:
calculate a score represented as a value that is larger as the image similarity is higher and is larger as the document similarity is higher; and
determine that the given condition is satisfied when the score is larger than a predetermined value.

5. The listed product information check system according to claim 2,
wherein each of the plurality of pieces of product information further includes price information on the product, and
wherein the at least one processor is configured to extract only a piece of regular sale product information including the price information which is equal to the price information included in the one piece of discount sale product information or is different from the one piece of discount sale product information by a predetermined amount or less.

6. The listed product information check system according to claim 5, wherein the at least one processor is configured to:
access an electric commerce system including:
a product information storage module configured to store the plurality of pieces of product information; and
a product page generation module configured to generate, based on each of the plurality of pieces of product information stored in the product information storage module, a product page including the seller information associated with the each of the plurality of pieces of product information and the image information, the document information, and the price information that are included in the each of the plurality of pieces of product information; and
acquire the plurality of pieces of regular sale product information from the product information storage module.

7. The listed product information check system according to claim 6, wherein the at least one processor is configured to:
transmit, to the product page generation module, a discount sale request for the product page relating to the one piece of discount sale product information and a regular sale request for the product page relating to the piece of regular sale product information determined to satisfy the given condition;
acquire the product page generated based on the discount sale request and the product page generated based on the regular sale request; and
output information represented by an image obtained by unifying two or more of the acquired product pages.

8. The listed product information check system according to claim 1, wherein the at least one processor is configured to:
acquire a plurality of pieces of discount sale product information with discount; and
output, for each of the plurality of pieces of discount sale product information, a combination of information on the plurality of pieces of discount sale product information and the piece of regular sale product information determined to satisfy the given condition.

9. The listed product information check system according to claim 1, wherein the document information further includes information representing a quantity of the product.

10. A non-transitory computer-readable storage medium having stored thereon a program to be executed by a computer, the program causing the computer to function as a listed product information check system configured to:
acquire a plurality of pieces of regular sale product information without discount from among a plurality of pieces of product information each including image information representing an image of a product and document information including a name of the product;
acquire one piece of discount sale product information with discount from among the plurality of pieces of product information;
calculate an image similarity being a similarity between the image information included in the one piece of discount sale product information and the image information included in each of the plurality of pieces of regular sale product information, and extract one or more pieces of regular sale product information including the image information similar to the image information included in the one piece of discount sale product information from among the acquired plurality of pieces of regular sale product information;
calculate a document similarity between the document information included in each of the extracted one or more pieces of regular sale product information and the document information included in the one piece of discount sale product information; and
output at least information on the one piece of discount sale product information when a piece of regular sale product information determined to satisfy a given condition based on the image similarity and the document similarity exists in the extracted one or more pieces of regular sale product information.
